(19) United States
(12) Patent Application Publication
(10) Pub. No.: US 2016/0140884 A1
(43) Pub. Date: May 19, 2016

(54) MOUNTING BOARD WITH NET MOUNTING MEANS

(71) Applicant: Brian M. Hall, Hull, MA (US)

(72) Inventor: Brian M. Hall, Hull, MA (US)

(21) Appl. No.: 14/946,703

(22) Filed: Nov. 19, 2015

Related U.S. Application Data
(60) Provisional application No. 62/081,845, filed on Nov. 19, 2014.

(51) Int. Cl. G09F 15/00

(52) U.S. Cl. CPC G09F 15/00; G09F 2015/0093

(57) ABSTRACT

A mounting board displays business cards, reminders, photographs, memorabilia and other items. The mounting surface of the mounting board is curved causing spring tension in the cords to press the business cards, reminders, photographs and other items in place. The benefit is a fastener free mounting board that allows placement of mounted items anywhere on the mounting board and mounting and dismounting of one item without disturbing the other items that are remaining on the mounting board.

### CROSS-REFERENCE TO RELATED APPLICATIONS

This application claims U.S. Provisional Application No. 62/081,845 filed on Nov. 19, 2014.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

The wall above the telephone or the face of an appliance or cabinet is frequently used as a building element mounting surface for business cards, reminders, photographs and other memorabilia. Holes, peeled paint, tape remnants and smudges on the building element mounting surface are often the result of direct mounting of these items. Bulletin boards with a surface that facilitates a particular type of fastener, such as cork for use with tacks, are often used to keep the damage off of the stationary mounting surface.

A more advanced bulletin board is well known for use without the need for separate fasteners as disclosed by Romanik U.S. 2009/0297753. Romanik's bulletin board, often referred to as a “ribbon board” has ribbons crisscrossing the mounting surface to hold items to the mounting surface of the board. Tension in the ribbons is held by the ribbon mounting around the edge of the mounting surface and is enhanced by fasteners between the ribbon and the mounting surface at each location where the ribbons cross. Ribbon boards solve the problem of damaging the stationary mounting surface with fasteners. However, ribbon boards limit the size and location of the items being displayed owing to the stationery fasteners at ribbon intersections.

### PRIOR ART

The following is art representative of what is published in the field of Bulletin Boards. Published Application No. U.S. 2009/0297753 to inventor Romanik discloses a Bulletin Board that has a ribbon holding items to the mounting surface and fasteners at the intersections of the ribbons. However, the disclosure of inventor Romanik lacks a solution to the problems of freedom of size of the mounted item, freedom of position of the mounted item and ribbon blocking the view of a substantial part of the face of the item.

### SUMMARY

The present invention solves the problem of size and placement of items on a ribbon board. This is accomplished by providing a curved shape to the mounting surface. The result is that the tension in the ribbon applied at the edges of the mounting board provides a gentile force between the ribbon and the mounting surface all the way across the mounting surface. This force between the ribbons and the mounting surface eliminates the need for the fasteners at the ribbon intersections. A lack of fasteners frees the user to place items of unlimited size in unlimited location on the mounting board.

Additional novel features of the present invention are:

Use of a transparent fishing line instead of an opaque ribbon further providing freedom of placement of an item without blocking the view of same. Provisions are also made for fastening multiple mounting boards together providing additional mounting space. Lastly provisions are made for fastening the bulletin firmly to the wall.

### OBJECTIVES

The primary objective of the present invention is to provide a mounting board with no loose fasteners that allows complete freedom of the size and position of an item being mounted. A further objective of the present invention is to replace the ribbons with thin, transparent cord, fishing line, to minimize obstruction of the mounted item.
A further objective of the present invention is no need for tacks, adhesive or tape that would cause damage to the mounted item;
A further objective of the present invention is no magnets holding the mounted material to the mounting board;
A further objective of the present invention is no connection between the transparent cord and the mounting board at the intersections of two transparent cords;
A further objective of the present invention is one item can be mounted moved or dismounted without disturbing the remaining mounted items;
A further objective of the present invention is the view of the material is not blocked;
A further objective of the present invention is curved surface of the mounting board lessens necessary tension in the transparent cord;
A further objective of the present invention is close spacing of transparent cords allows easy mounting of small items.
A further objective of the present invention is to provide mounting for one mounting board to another to expand the mounting board size.

In the achievement of the aforementioned objectives the present invention also provides unrelated additional features:
The primary additional feature is to provide mounting that allows the board to be placed with either of the four sides up.

### BRIEF DESCRIPTION OF THE SEVERAL VIEWS OF THE DRAWING(S)

FIG. 1(a) is a rear view of the present invention,

FIG. 1(b) is a left edge view of the present invention,

FIG. 1(c) is a front view of the present invention,

FIG. 1(d) is a top view of the present invention.

FIG. 2 is a view of the fastening alternatives of the transparent cords to the present invention.

FIG. 3(a): Is a front view of the cylindrical assembly of the present invention.

FIG. 3(b): Is a top view of the cylindrical assembly of the present invention.

FIG. 4: Is three views of a clip for fastening the cords to the edge of the mounting surface.

FIG. 5: Is a front view of two adjoining mounting boards that are interlocked together.

### DETAILED DESCRIPTION OF THE INVENTION

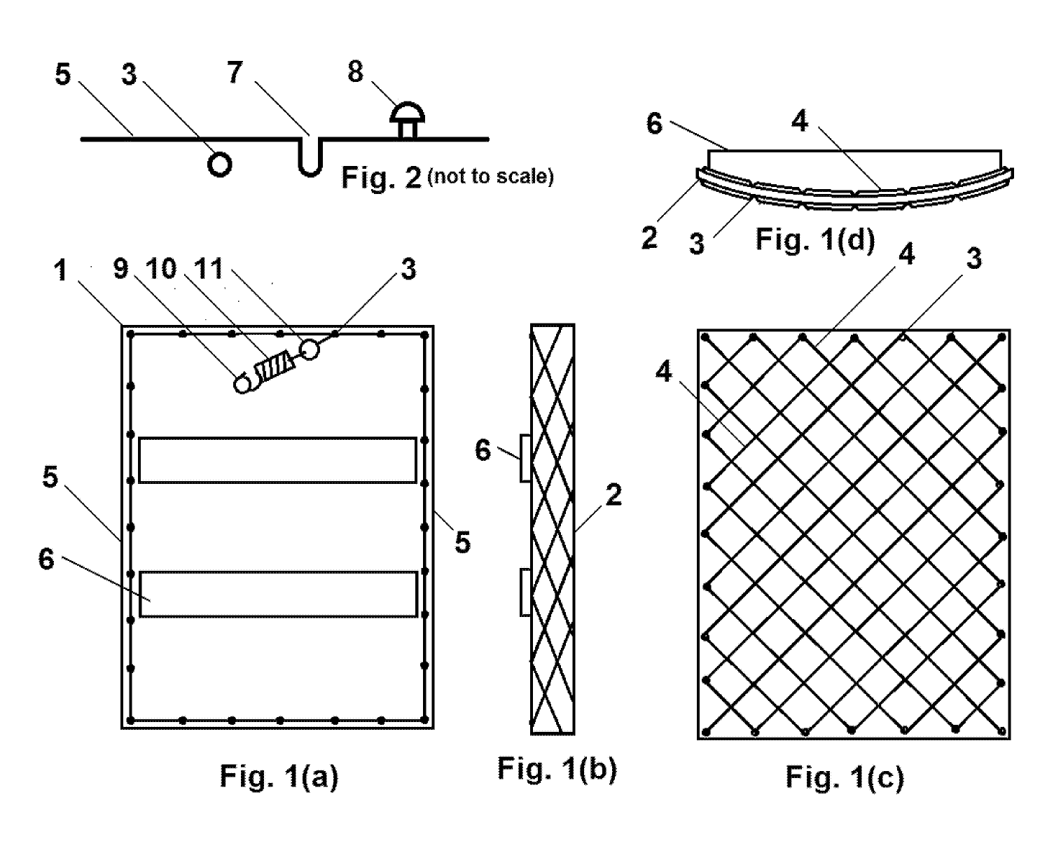

The preferred embodiment of the present invention, mounting board 1 is shown in FIG. 1(a) which is a rear view, FIG. 1(b) which is a left edge view, FIG. 1(c) which is a front view and FIG. 1(d) which is a top view. The mounting surface 2 is the face of the mounting board 1 where items are mounted and is curved, See FIG. 1(d). The mounting surface is surrounded by a plurality of edges 5. Mounting holes 3 are located around the perimeter of the front surface 2 and are threaded with a transparent cord 4. Transparent cord 4 is woven through the mounting holes 3 as shown at FIG. 1(d). Items (un-shown) are mounted between transparent cord 4 and mounting surface 2 by tension in transparent cord 4. The cord has a loop 11 at the end. A tension spring 10 pulls the loop 11 towards the spring mounting post 9. The cumulative tension in the multiple transparent cords 4 tends to bend the mounting surface 2 of the mounting board 1. Ribs 6 strengthen the assembly and reduce the bending of front surface 2.

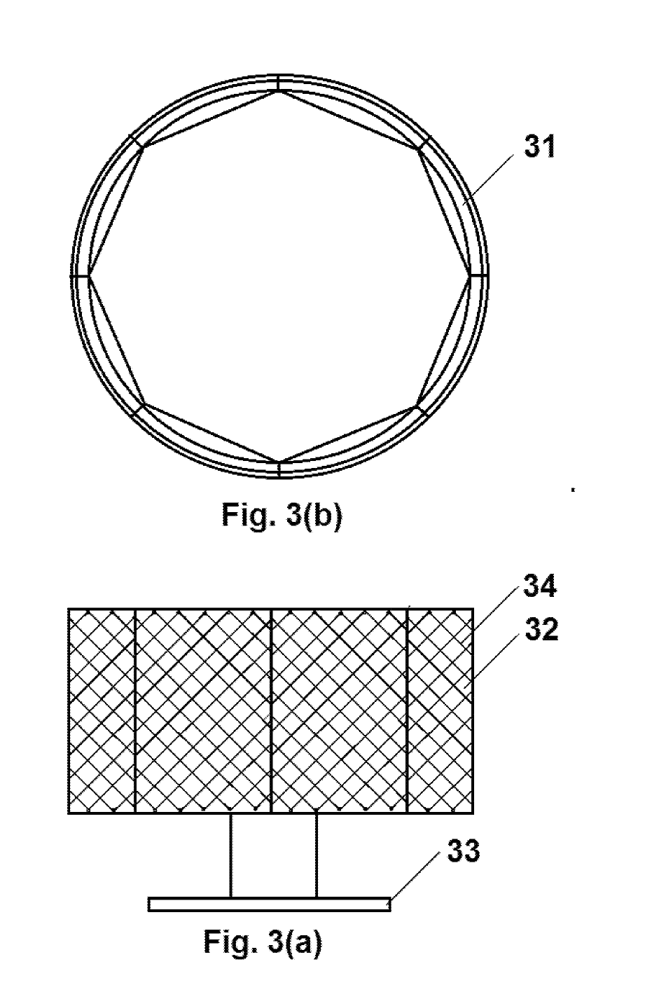

FIG. 3(a) is a front view of an alternate embodiment of the present invention where eight mounting boards 31 are joined to form a cylindrical mounting board. FIG. 3(b) is a top view of FIG. 3(a). The mounting surface 32 forms the periphery of one of the eight mounting boards 31. Cord 33 holds items against the mounting surface 32. The base 33 is used to set the assembly on a flat surface or a floor.

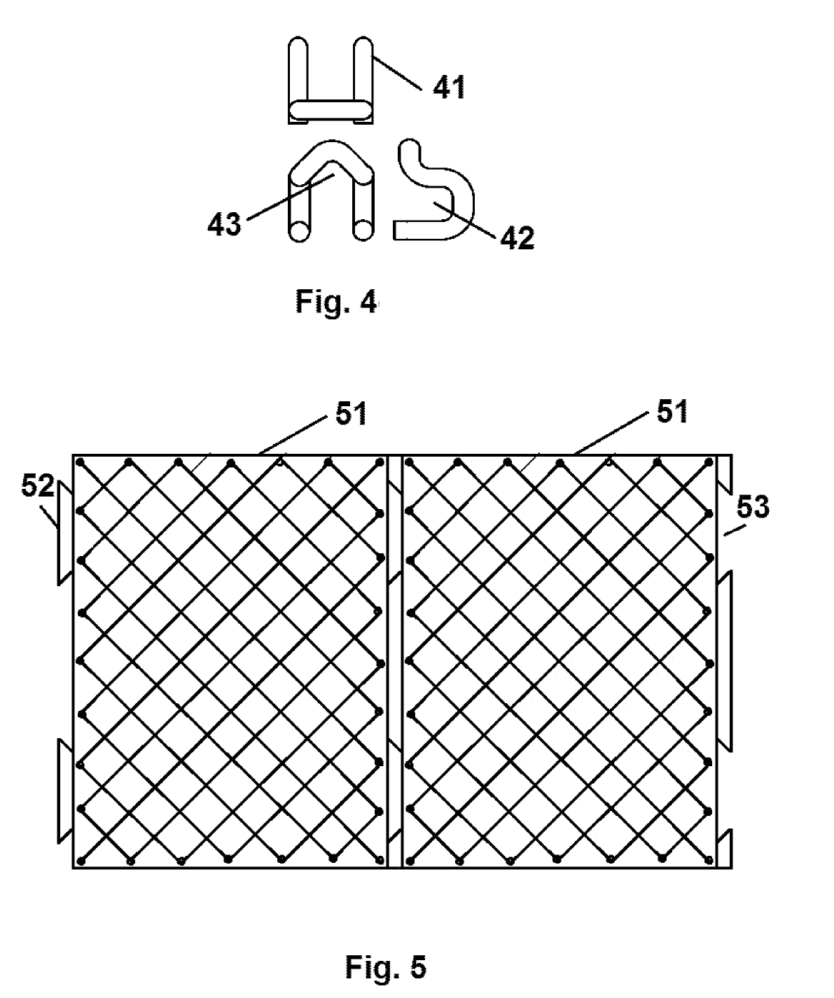

FIG. 4 shows a clip 41 that is used to trap a piece of cloth or other sheet material (un-shown) to the mounting surface (un-shown) by trapping it between the U shaped opening 42 and the edge of the mounting board (unshown). The cords (un-shown) are threaded through the opening 43 at the top of the clip 41.

FIG. 5 shows two mounting boards 51 held together by engagement of male dovetails 52 and female dovetails 53. The dovetails 52 and 53 may also be used to fasten a frame (un-shown) around one or more mounting boards 51.

In another embodiment the cord (un-shown) serves as a component of a light source (un-shown) such as an optical fiber (un-shown);

In still another embodiment an axis (un-shown) of the curve (un-shown) of the mounting surface (un-shown) can be oriented in any direction in relation to the plurality of edges (un-shown) of the mounting board apparatus (un-shown);

In still a further embodiment the curvature of the mounting surface (un-shown) may be spherical in shape (un-shown);

In a further embodiment mounting surface (un-shown) may be any color, pattern, texture, compressibility or reflectivity (un-shown);

In a further embodiment of the present invention the mounting surface (un-shown) may be discontinuous (un-shown);

In another embodiment of the present invention the spacing or angularity of the cords (un-shown) may be varied to form a pattern (un-shown);

In another embodiment the cord may be joined at the intersections (un-shown) forming a net like structure (un-shown).

In still another embodiment the plurality of holes, notches, protrusions or clips (un-shown) may be omitted along one or more edges (un-shown) to allow for sliding a large object (un-shown) onto the mounting board apparatus (un-shown).

Although the terms and definitions used in the specification are intended to be read into the claims they are hot intended to limit the meets and bounds of the claims presented here below in any manner whatsoever.

I claim:

1. A mounting board apparatus for displaying photographs, cards, tickets, signs and flat printed material with a novel apparatus for mounting the displayed material:
a front surface for mounting the photographs, business cards, tickets, signs and flat printed material;
a back surface for supporting the mounting board apparatus against a building element;
a plurality of edges for defining an exterior shape of the mounting surface;
a plurality of holes, notches, protrusions or clips along the plurality of edges for holding a cord in place relative to the mounting surface and the plurality of edges.

2. The mounting board apparatus of claim 1, wherein the front surface forms a curve relative to the back surface.

3. The mounting board apparatus of claim 2, wherein two opposing edges are closer to the back surface then a center of the mounting surface.

4. The mounting board apparatus of claim 3, wherein the cord passes through the plurality of holes, notches, protrusions or clips and traverses the mounting surface.

5. The mounting board apparatus of claim 4, wherein a tensile force in the cord presses the cord against the mounting surface

6. The mounting board apparatus of claim 5, wherein the tensile force in the cord is maintained by a resilient element.

7. The mounting board apparatus of claim 6, wherein the resilient element is a tension spring.

8. The mounting board apparatus of claim 6, wherein the cord is transparent.

9. The mounting board apparatus of claim 6, wherein the plurality of edges are made to fasten adjacent mounting board apparatuses together.

10. The mounting board apparatus of claim 6, wherein a plurality of apparatuses can be joined at the plurality of edges to form a cylinder.

11. The mounting board apparatus of claim 6, wherein the edges that are made to fasten the adjacent apparatuses together also fasten a frame surrounding a single apparatus.

12. The mounting board apparatus of claim 6, wherein the cord serves as a component of a light source.

13. The mounting board apparatus of claim 6, wherein the axis of the curve of the mounting surface can be oriented in any direction in relation to the plurality of edges of the mounting board apparatus.

14. The mounting board apparatus of claim 6, wherein the curvature of the mounting surface may be spherical in shape.

15. The mounting board apparatus of claim 6, wherein the mounting surface may be any color, pattern, texture, compressibility or reflectivity.

16. The mounting board apparatus of claim 6, wherein the mounting surface may be discontinuous.

17. The mounting board apparatus of claim 6, wherein the spacing or angularity of the cords may be varied to form a pattern.

18. The mounting board apparatus of claim 6, wherein the cords may be joined at the intersections forming a net like structure.

19. The mounting board apparatus of claim 6, wherein the plurality of holes, notches, protrusions or clips may be omitted along one or more of the plurality of edges to allow for sliding a large object onto the mounting board apparatus.
